(19) United States
(12) Patent Application Publication
(10) Pub. No.: US 2016/0309691 A1
(43) Pub. Date: Oct. 27, 2016

(54) SURFACE AND SUBSURFACE DISPENSER FOR FISH BAIT AND FISH FOOD

(71) Applicant: John Ancona, Fleming Island, FL (US)

(72) Inventor: John Ancona, Fleming Island, FL (US)

(21) Appl. No.: 15/137,497

(22) Filed: Apr. 25, 2016

Related U.S. Application Data
(60) Provisional application No. 62/152,522, filed on Apr. 24, 2015.

(51) Int. Cl. A01K 97/02; A01K 91/03; A01K 93/00

(52) U.S. Cl. CPC A01K 97/02; A01K 93/00; A01K 91/03

(57) ABSTRACT

A fish bait dispenser includes a perforated fish bait container with a buoyant element, such as a cork, that provides sufficient buoyancy to cause the fish bait container to float. A line extends through holes in the container. A line lock, slidably attached but easily removable from a portion of line extending from the top of the container defines the depth at which the container will float. A weight attached to the distal end of the line anchors the container. A float, such as a bobber, freely attached above the line lock indicates location of the subsurface fish bait dispenser.

### RELATED APPLICATION

This application is a nonprovisional of and claims the benefit of priority of U.S. provisional application No. 62/152,522 filed Apr. 24, 2015, the entire contents of which are incorporated herein by this reference.

### FIELD OF THE INVENTION

This invention relates to a fish bait or fish food dispensing device which is adapted for use to attract fish during surface, bottom and/or float fishing, or for feeding fish in ponds or aquariums, and, more particularly, to a fish bait or fish food dispenser that floats at a depth set by a user and releases fish bait or fish food at the set depth.

### BACKGROUND

The advantages of using fish bait, e.g., pieces of ground up fish (aka chum), as a means of attracting fish prior to their being caught by net or hook are well known. Many devices have been employed to dispense and distribute fish bait. By way of example, as anyone who has seen the movie Jaws will know, anglers frequently shovel fish bait, from a bucket on a boat, into the water at the stern. In addition, anglers will drag a mesh bag of fish bait behind a boat. Thus, a wide variety of fish bait dispensing devices are presently in use or are available to fishermen. Prior devices are mostly used for fishing offshore or open waterways and not designed for inland or generally more shallow water usage.

Many prior fish bait dispensing devices, while suitable for their intended purpose, do not adequately dispense fish bait at a particular, preset, but adjustable, depth. An angler who is line fishing for fish at a depth of 5, 25 or 50 feet, may not benefit from fish bait dispensed at the water's surface or at the seabed. Much of the fish bait dispensed at the surface may be consumed, dissipate and drift away long before it reaches the desired depth in the area being fished. Fish bait dispensed at a seabed may, at best, attract a few bottom feeders, no mid-depth or surface feeders, and no fish at all if the seabed includes considerable debris and/or growth.

A dispenser that operates at a user selectable depth is needed. The dispenser should be suitable for dispensing fish bait or fish food. The dispenser should be durable, easy to use, re-usable, reliable and relatively inexpensive. The dispenser must also be effective, particularly effective for attracting fish to the vicinity of an angler's line.

The invention is directed to overcoming one or more of the problems and solving one or more of the needs as set forth above.

### SUMMARY OF THE INVENTION

To solve one or more of the problems set forth above, in an exemplary implementation of the invention, a surface or controlled subsurface fish bait dispenser includes a container with perforations and a removable cover for refilling with fish bait. The fish bait mixes with water and dispenses through the perforations. The container also contains a buoyant element, such as a cork, that provides sufficient buoyant force to cause the fish bait container to ascend in the water, even when filled with fish bait.

The top (e.g., lid) and bottom of the fish bait container include a hole, i.e., aperture, through which a line extends. The line, which may be made of any variety of materials, e.g., cord or line, extends from a reel such as a manual hand reel or from a spool (or other device) to facilitate winding and storage. The proximal end of the line engages the reel or spool.

A line lock is slidably attached to the portion of the line extending from the top of the fish bait container. The preferred line lock can easily be removed without disturbing other components. The line lock grips a portion of the line. The gripped portion of the line is user-selectable. The line lock is larger than the aperture in the top of the fish bait container. Thus, the fish bait container cannot ascend beyond the line lock. The line lock thus defines the depth at which the fish bait container will float. When the line lock is removed, the bait dispenser will float on and dispense bait at the surface.

A weight is attached to the distal end of the line that extends through the bottom of container. The buoyant force provided by the buoyant element is insufficient to cause the weight to ascend. The fish bait container may move along the line between the weight and line lock. Buoyancy maintains the fish bait container against the line lock, without lifting the weight. Thus, the weight is selected with sufficient mass to anchor the dispenser.

A float, such as a bobber, is freely attached to the line, allowing it to move as needed between the line lock and proximal end of the line. Ideally, the fish bait container floats about directly beneath the float. Thus, the float is useful for indicating the approximate location of the fish bait dispenser and as a general guide for proximity to cast baited and hooked lines. Any buoyancy of the float in combination with buoyancy of the buoyant element within the fish bait container is still insufficient to cause the weight to ascend. Thus, the weight is selected with sufficient mass to anchor the dispenser and float.

As a pond or aquarium fish feeder, fish food or pellets are added to the container and placed in the pond or aquarium for the purpose of feeding the fish. Use of the dispenser helps keep water cleaner than throwing food into the water, as fish will feed at the container, and less food is wasted. The dispenser is also useful for feeding fish during extended periods of time, such as while a caregiver is away or on vacation.

An exemplary buoyant dispenser for fish bait according to principles of the invention includes a container assembly with a removable cover and buoyant element, a line lock and a sinker. These components are arranged on a line while fishing, with the container assembly disposed between the line lock and the sinker. The line lock defines the upper limit of motion of the container assembly due to buoyancy. Optionally, a bobber (fishing float) may be attached to the line above the line lock (i.e., between the reel device and the line lock).

The container assembly has an outer surface defining a receptacle with an interior compartment for holding fish bait and an opening into the interior compartment. A plurality of perforations extend from the interior compartment through the outer surface. The outer surface defining the receptacle includes an upper portion and a lower portion. An upper hole in the upper portion has an upper hole width. A lower hole in the lower portion has a lower hole width. The upper hole is aligned with the lower hole. The upper hole extends from the interior compartment at the upper portion. The lower hole extends from the interior compartment at the lower portion. The upper hole and the lower hole are in alignment and define a passage through the container assembly. The upper hole or the lower hole may be formed in the cover removably attached to the receptacle over the opening. The passage is configured to receive a line and allow sliding motion of the container assembly relative to the line. Additionally, the upper portion has another hole that allows venting of air bubble to escape, thus allowing the container to fill completely with water when submerged. The additional upper hole extends from the interior compartment at the upper portion.

A cover is removably attached to the receptacle over the opening. The cover may threadedly engage the opening or snap fit to the opening. In one preferred embodiment, the outer surface includes a threaded neck through which the opening extends. In this embodiment the cover threadedly engages the neck. In another embodiment the cover snap fits to the opening.

A buoyant element produces a buoyant force when the container assembly is submerged in water. The buoyant force exceeds the weight of the container assembly. The buoyant element may comprise a buoyant object that is inserted into the interior compartment through the opening and contained in the interior compartment. The buoyant element may have a channel extending through it. That channel may align with the passage of the container assembly, allowing the line to extend through the passage and the channel. Nonlimiting examples of buoyant elements include (a) a cork that fits through the opening in the container assembly and fits in the interior compartment of the container assembly; (b) a closed cell foam; (c) an inflated bladder; (d) a hermetically sealed hollow plastic float that fits through the opening in the container assembly and fits in the interior compartment of the container assembly; (e) a cork that fits through the opening in the container assembly and fits in the interior compartment of the container assembly, with the cork having a top and a bottom and a channel extending from the top to the bottom and defining a cork passage that is alignable with the passage through the container assembly or (f) a container assembly designed to be the buoyant element through use of buoyant materials or assembly procedures.

A line lock includes a line gripping member and has a line lock width greater than the upper hole width and greater than the lower hole width. The line gripping member releasably secures the line lock to a line. A user may position the line lock on the line at whatever point will be the upper limit of motion of the container assembly. As one example, the line lock may include a body, with the gripping member being a narrow slit in the body that grips a line. As another example, the line lock may include a body with a first channel extending through the body, a second channel spaced apart from the first channel and extending through the body and having a second hole width, and a slit extending at an angle partially through the body to the second channel and having a slit width that is less than the channel width. As another example, the gripping member may be a clamp, such as a spring biased clamp. As another example, the line lock may comprise a body of malleable material (e.g., a metal such as lead, steel, aluminum, brass, bismuth, tungsten or an alloy) with a slit in the body for receiving a portion of the line.

A sinker having a sinker weight is attached towards the free end of the line. The sinker weight exceeds the buoyant force. Thus, the buoyant force is sufficient to support the container assembly, but not sufficient to support the sinker weight.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side view of an exemplary depth defined dispenser according to principles of the invention; and

FIG. 2 is perspective view of an exemplary depth defined dispenser according to principles of the invention; and

FIG. 3 is a side exploded view of an exemplary fish bait container assembly for a depth defined dispenser according to principles of the invention; and

FIG. 4 is perspective exploded view of an exemplary fish bait container assembly for a depth defined dispenser according to principles of the invention; and

FIG. 5 is a side view of an exemplary line lock for a depth defined dispenser according to principles of the invention; and

FIG. 6 is another side view of an exemplary line lock for a depth defined dispenser according to principles of the invention; and

FIG. 7 is a perspective view of an exemplary line lock for a depth defined dispenser according to principles of the invention; and

FIG. 8 is perspective view of an alternative exemplary line lock for a depth defined dispenser according to principles of the invention; and

FIG. 9 is another perspective view of an alternative exemplary line lock for a depth defined dispenser according to principles of the invention; and

FIG. 10 is a side view of another alternative exemplary line lock for a depth defined dispenser according to principles of the invention; and

FIG. 11 is a perspective view of the other alternative exemplary line lock for a depth defined dispenser according to principles of the invention; and

FIG. 12 is a perspective view of the other alternative exemplary line lock for a depth defined dispenser according to principles of the invention; and

FIG. 13 is a side view of an exemplary depth defined dispenser used with a fishing rig according to principles of the invention; and

FIG. 14 is a section view of an exemplary buoyant container for a depth defined dispenser according to principles of the invention; and

FIG. 15 is a perspective view of another exemplary line lock for a depth defined dispenser according to principles of the invention; and

FIG. 16 is a plan view of the other exemplary line lock for a depth defined dispenser according to principles of the invention; and

FIG. 17 is another perspective view of the other exemplary line lock for a depth defined dispenser according to principles of the invention; and

FIG. 18 is another plan view of the other exemplary line lock for a depth defined dispenser according to principles of the invention; and

FIG. 19 is a perspective view of yet another exemplary line lock for a depth defined dispenser according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

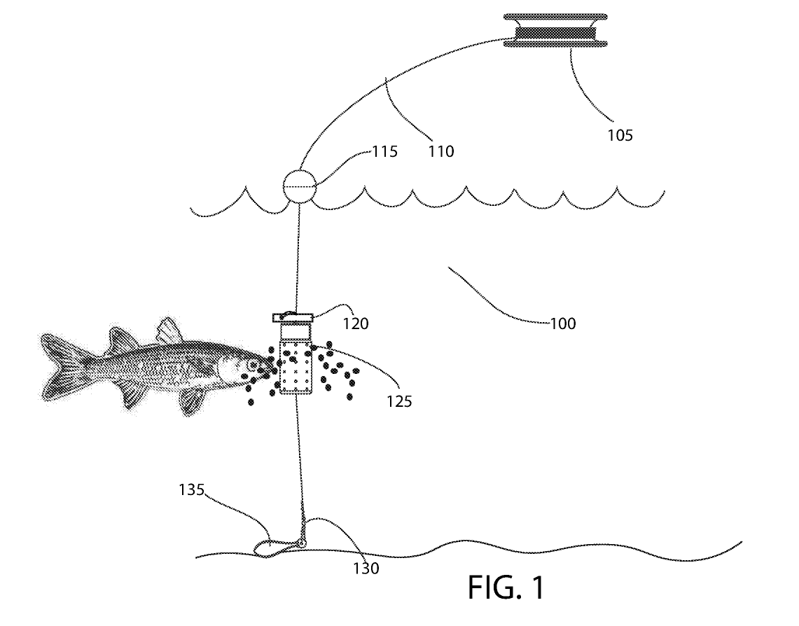

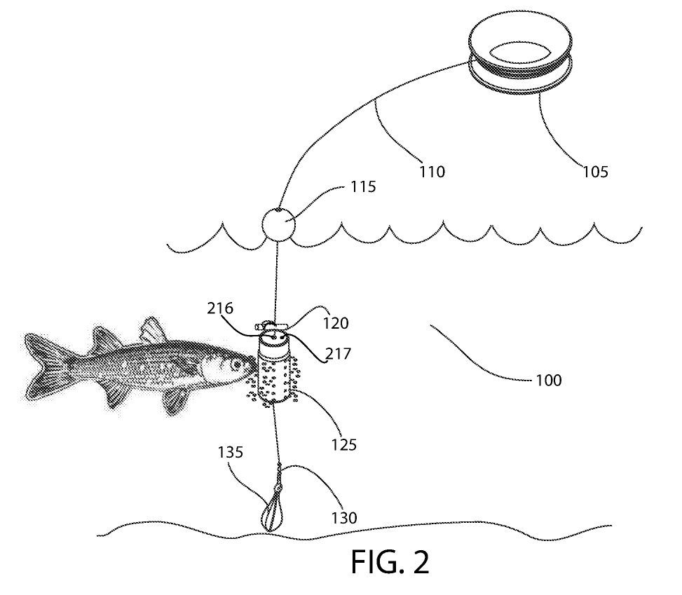

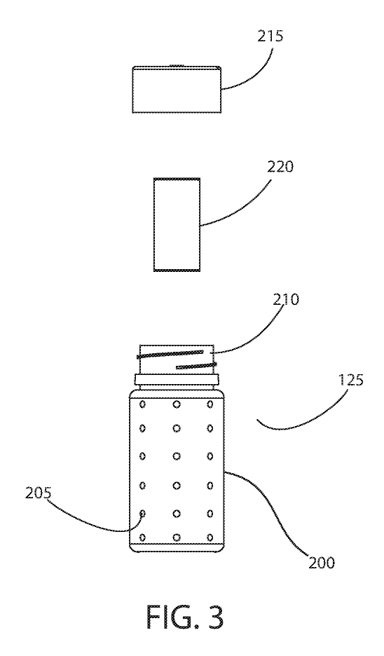

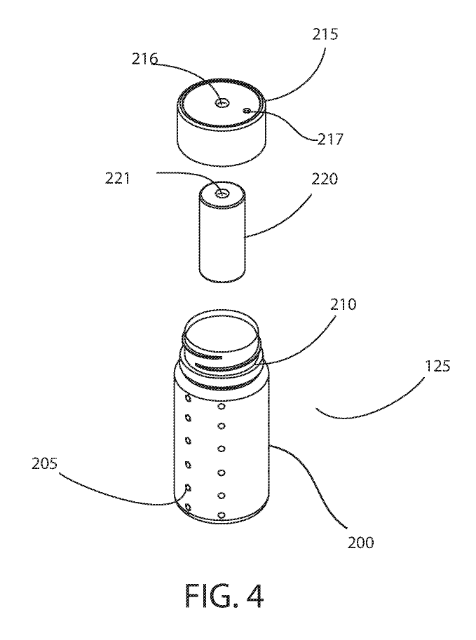

With reference to FIGS. 1 through 4, a depth defined fish bait dispenser 100 includes a container 125 with perforations 205 and a removable cover 215. The container 125 includes a body 200 (wall surface) that defines a compartment for storing, deploying or embodying a buoyant element a buoyant element 220 and fish bait or fish food. The cover 215 threadedly mates with a threaded neck 210 or other method of securing the removable cover to the container 125. Chum or food mixes with water flowing through the perforations 205.

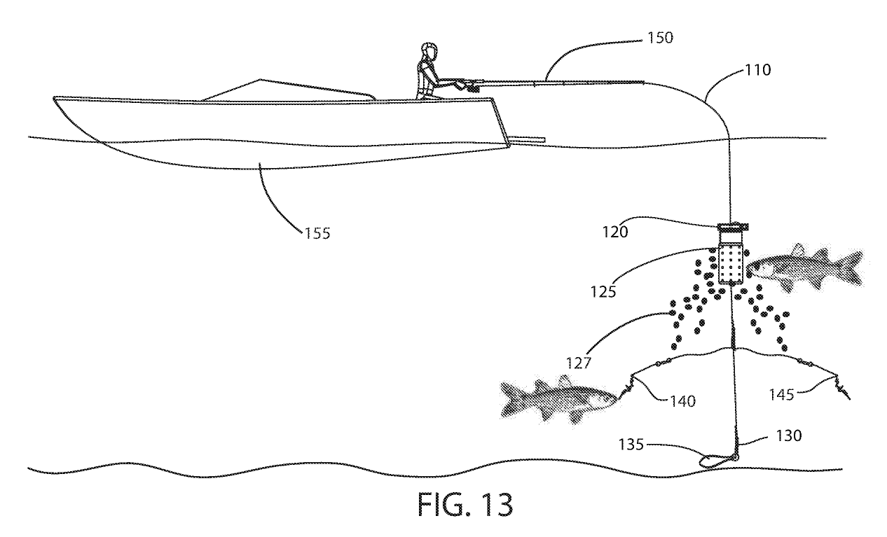

The depth defined fish bait dispenser 100 may be used from a pier, shore, boat or any other place from which fish may be fed or caught. The depth defined fish bait dispenser 100 may be used as part of a fishing rig, as conceptually illustrated in FIG. 13, or may be used separate from a fishing rig. One or more depth defined fish bait dispensers 100 may be used simultaneously.

The buoyant element 220, such as cork, provides sufficient buoyant force to cause the fish bait container 125 to ascend in the water when filled with fish bait. Any buoyant element 220 that fits within the container body 200, or is embodied to the container body, along with contained fish bait and provides sufficient buoyancy to cause the fish bait laden container 125 to ascend in water may be used. Nonlimiting examples of other floats that may be used include closed cell foams, gas (e.g., air) filled hermetically sealed bladders, or lightweight hermetically sealed containers.

The top (e.g., lid 215) and bottom of the fish bait container 125 include a hole 216, i.e., aperture, through which a line 110 extends. Likewise, the cork 220 has a channel 221 extending through the cork. The top also contains and additional hole, i.e., vent hole 217, to allow air bubbles to vent out of the container. The vent hole 217 is separate from hole 216.

The line 110, which extends through the top and bottom holes of the container 125 also extends through the channel 221. The line 110 may extend from a reel such as a manual hand reel 105 or from a spool or other device to facilitate winding and storage. The proximal end of the line 110 engages the reel 105 or spool. The line may be a monofilament, cofilament, braided or twisted line, thermally fused lines or other sufficiently strong flexible tether that is suitable for aquatic use.

A line lock 120 is slidably attached to the portion of the line 110 extending from the top of the fish bait container. The line lock 120 grips a portion of the line. The gripped portion of the line 110 is user-selectable. This means that a user may position the line lock 120 at a certain location along the line 110 between the float 115 and the container 125. The line lock 120 is larger than the aperture 216 in the top of the fish bait container 125. Thus, the fish bait container 125 cannot ascend, under the influence of buoyancy, beyond the line lock 120. The line lock 120 thus defines the depth at which the fish bait container 125 will float, which is preferably a depth below the water's surface. When the line lock is removed, the bait dispenser will float on and dispense bait at the surface.

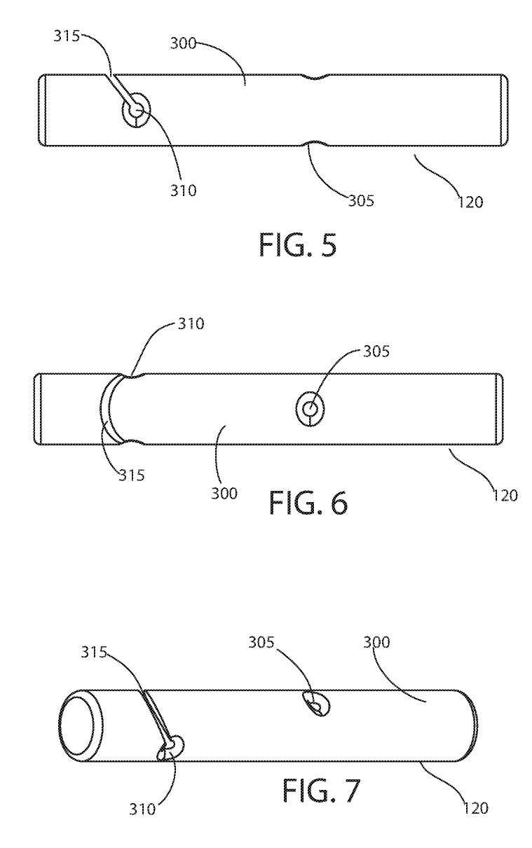

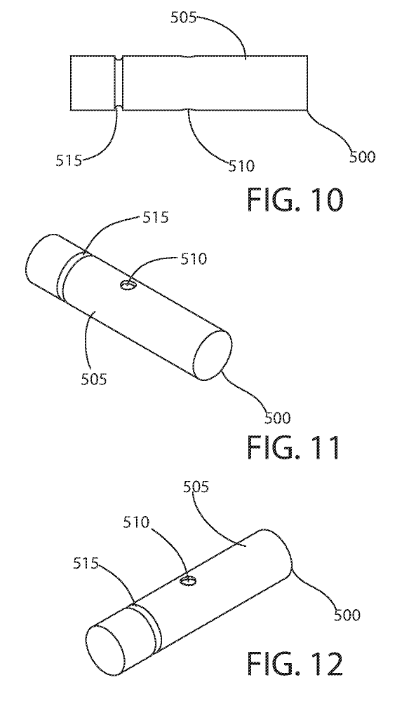

FIGS. 5 through 12 provide nonlimiting examples of line locks. Any device suitable for aquatic use and defining a stop on the line may be used. In the exemplary line lock 120 shown in FIGS. 5 through 7, a perforated barrel with a retaining slotted channel is provided. The exemplary line lock 120 includes a barrel body 300 with a slotted channel 310, with a slot 315 extending through a side of the barrel body 300 to the channel 310. Another channel 305 is spaced apart from and orthogonal to the slotted channel 310. A loop of line extends through the channel 305, and passes through the slot 315 to extend through the slotted channel 310. The slot 315 may be sufficiently narrow to resist inadvertent withdrawal of the engaged line. The barrel body 300 may exhibit flexibility to increase the slot 315 width to facilitate insertion and removal of an engaged portion of line. The lock may be positioned, repositioned and removed without disturbing other components of the dispenser 100. When engaged by the line supporting the weight 135, the line lock 120 frictionally resists movement.

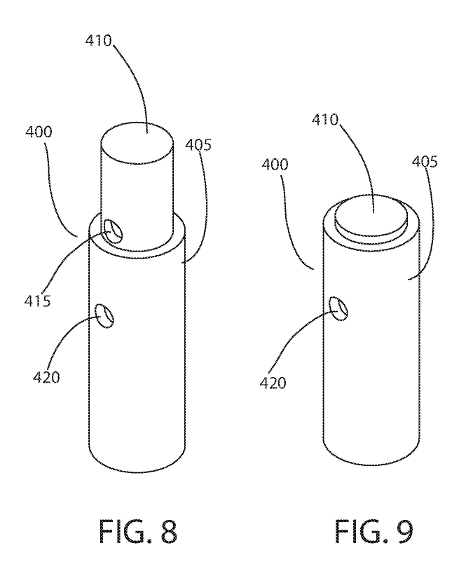

In another exemplary line lock 400 as shown in FIGS. 8 and 9, a spring biased barrel 410 is partially contained in a sleeve 405. Channels 415, 420 extend through the barrel 410 and sleeve 420, respectively. The channels 415, 420 are urged apart by the spring. When the barrel 410 is pressed into the sleeve 405, compressing the spring, the channels 415, 420 align. With the channels 415, 420 aligned, the line may be threaded through the channels 415, 420. When the barrel 410 is released, the channels 415, 420 separate and frictionally secure the engaged line. Thus a user may quickly adjust the position of the line lock by pressing the barrel 420, and sliding the line lock to the desired position on the line, and then releasing the barrel 420. When engaged by the line supporting the weight 135, the line lock 120 frictionally resists movement.

In yet another exemplary line lock as illustrated in FIGS. 10 through 12 a barrel 500 includes a channel 505 extending through, orthogonal to the longitudinal axis of the barrel 500. The line extends through the channel 505 of the barrel. A portion of the line wraps around the retaining ring 510, which is a peripheral groove in the barrel 500. When engaged by the line supporting the weight 135, the line lock 120 frictionally resists movement.

A weight 135 is attached to the distal end of the line 110 that extends through the bottom of container. The weight 135 may be attached with a swivel 130 having a clasp to facilitate removal, such as for use while drift fishing. The buoyant force provided by the buoyant element (i.e., cork 220) is insufficient to cause the weight 135 to ascend. The fish bait container 125 may move along the line between the weight 135 and line lock 120. Buoyancy maintains the fish bait container 125 against the line lock 120, without lifting the weight 135. Thus, the weight 135 is selected with sufficient mass to anchor the dispenser. Various weights may be tried until a weight of sufficient mass to adequately anchor the fish bait dispenser is selected. The mass will vary depending upon the fish bait container 125 and cork 220 materials and properties, including size.

A float 115, such as a bobber, is freely attached to the line 110 between the line lock 120 and proximal end of the line 110. Ideally, the fish bait container 125 floats about directly beneath the float 115. Thus, the float indicates the approximate location of the fish bait container 125 floating beneath the water's surface. Any buoyancy of the float 115 in combination with buoyancy of the buoyant element 220 within the fish bait container 125 is still insufficient to cause the weight 135 to ascend. Thus, the weight 135 is selected with sufficient mass to anchor the container 125 and float 115.

In FIG. 13 a schematic of an exemplary depth defined dispenser used with a fishing rig according to principles of the invention is provided. A line 110 extends from a fishing pole 150 used by an angler on a boat 135, or from a shore or pier. The container assembly 125 is disposed between the line lock 120 and sinker 135. A swivel 130 couples the sinker to the line 110. A pair of leaders terminating with baited fish hooks 140, 145 are disposed between the container assembly 125 and the sinker 135. Bait 127 from the container assembly 125 descends to the baited hooks 140, 145, to attract fish to the baited hooks 140, 145. The line lock 120 can be positioned at any desired depth above the sinker 135. The position of the line lock 120 defines the upper limit of motion of the container assembly 125. The buoyancy of the container assembly 125, due to its buoyant element, causes the container assembly to float up to the line lock 120. However, the buoyancy is not sufficient to lift the sinker 135 off the seabed.

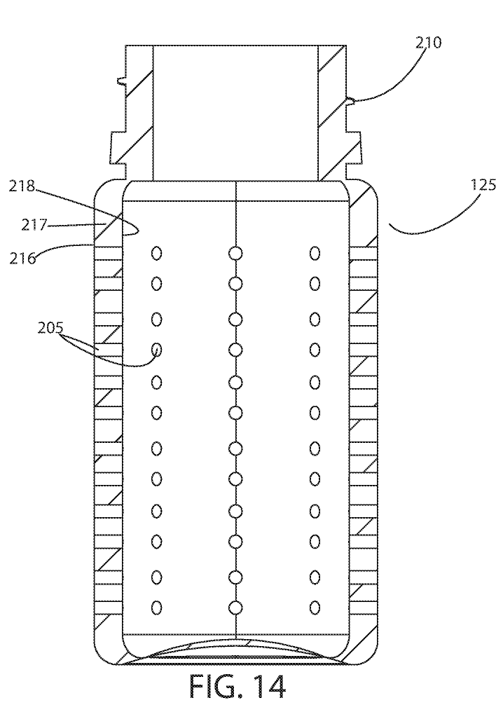

In FIG. 14, a section view of an exemplary buoyant container assembly 125 for a depth defined dispenser according to principles of the invention is provided. The cover 215 is removed. The container is double walled, with an outer wall 216, an inner wall 218 and a buoyant filler 217 between the outer and inner walls 216, 218, together comprising a double wall structure that defines an interior compartment for storing bait. Perforations 205 extend through the double wall structure to the interior compartment. The buoyant filler 217 may comprise a foam, such as a closed cell foam. The buoyant filler 217 provides the requisite buoyancy.

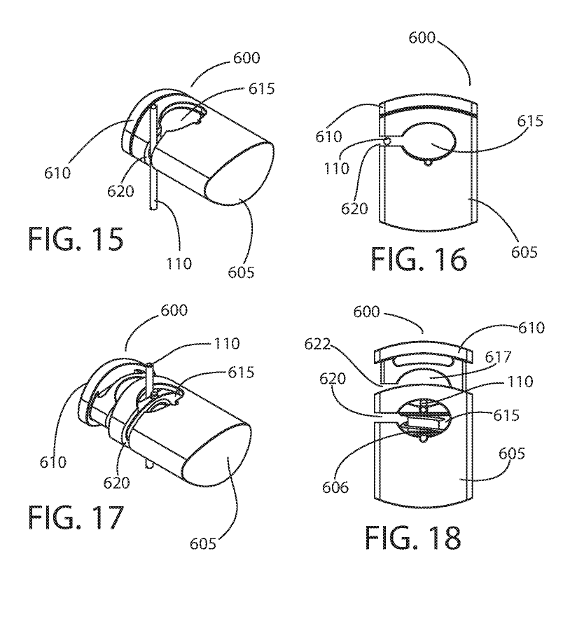

FIGS. 15 through 18 illustrate another exemplary line lock for a depth defined dispenser according to principles of the invention. This line lock 600 includes a barrel 605, a plunger 610, alignable holes 615, 617 in the barrel 605 and plunger 610, alignable slots 620, 622 in the barrel 605 and plunger 610, and a spring 606. When the barrel 605 and plunger 610 are squeezed together, the slots 620, 622 and holes 615, 617 align. Then a line may be slid through the slots 620, 622 into the holes 615, 617. When the plunger 610 is released, the spring 606 urges the plunger 610 away from the barrel 605, with the slots 620, 622 and holes 615, 617, no longer being in alignment. The line 110 is clamped between the unaligned holes.

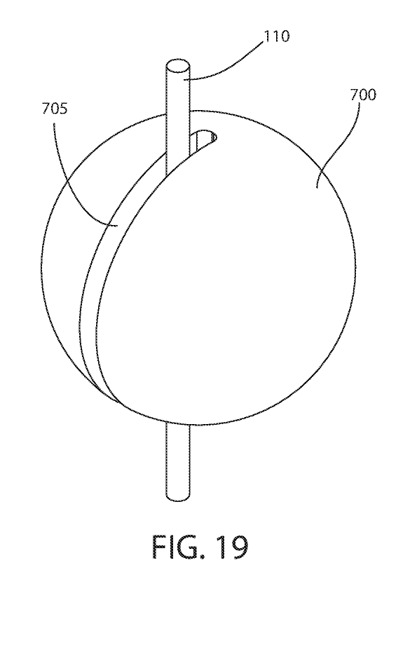

FIG. 19 is a perspective view of yet another exemplary line lock for a depth defined dispenser according to principles of the invention. This particular line lock includes a malleable body 700 with a slit 705 having a width sufficient to receive a line 110. When squeezed the slit narrows and clamps the line 110. Examples of such line locks include fishing split shot. While a spherical body is illustrated, such a line lock may have other shapes. As lead is known to cause lead poisoning and enter the environment as a result of the inevitable occasional loss of fishing sinkers, malleable metals other than lead may be used, such as steel, brass, bismuth, tungsten, and alloys containing any of the foregoing.

In sum, an exemplary buoyant dispenser for fish bait according to principles of the invention includes a container assembly with a removable cover and buoyant element, a line lock and a sinker. These components are arranged on a line, with the container assembly disposed between the line lock and the sinker. The line lock defines the upper limit of motion of the container assembly due to buoyancy. Optionally, a bobber (fishing float) may be attached to the line above the line lock (i.e., between a fishing reel device and the line lock).

The container assembly has an outer surface defining a receptacle with an interior compartment for holding fish bait and an opening into the interior compartment. A plurality of perforations extend from the interior compartment through the outer surface. The outer surface defining the receptacle includes an upper portion and a lower portion. An upper hole in the upper portion has an upper hole width. A lower hole in the lower portion has a lower hole width. The upper hole is aligned with the lower hole. The upper hole extends from the interior compartment at the upper portion. The lower hole extends from the interior compartment at the lower portion. The upper hole and the lower hole are in alignment and define a passage through the container assembly. The upper hole or the lower hole may be formed in the cover removably attached to the receptacle over the opening. The passage is configured to receive a line and allow sliding motion of the container assembly relative to the line. Additionally, the upper portion has another hole that allows venting of air bubbles to escape, thus allowing the container to fill completely with water when submerged. The additional upper hole extends from the interior compartment at the upper portion.

A cover is removably attached to the receptacle over the opening. The cover may threadedly engage the opening or snap fit to the opening. In one preferred embodiment, the outer surface includes a threaded neck through which the opening extends. In this embodiment the cover threadedly engages the neck. In another embodiment the cover snap fits to the opening.

A buoyant element produces a buoyant force when the container assembly is submerged in water. The buoyant force exceeds the weight of the container assembly. The buoyant element may comprise a buoyant object that is inserted into the interior compartment through the opening and contained in the interior compartment. The buoyant element may have a channel extending through it. That channel may align with the passage of the container assembly, allowing the line to extend through the passage and the channel. Nonlimiting examples of buoyant elements include (a) a cork that fits through the opening in the container assembly and fits in the interior compartment of the container assembly; (b) a closed cell foam; (c) an inflated bladder; (d) a hermetically sealed hollow plastic float that fits through the opening in the container assembly and fits in the interior compartment of the container assembly; (e) a cork that fits through the opening in the container assembly and fits in the interior compartment of the container assembly, with the cork having a top and a bottom and a channel extending from the top to the bottom and defining a cork passage that is alignable with the passage through the container assembly; (f) a container assembly designed to be the buoyant element through use of buoyant materials or assembly procedures.

A line lock includes a line gripping member and has a line lock width greater than the upper hole width and greater than the lower hole width. The line gripping member releasably secures the line lock to a line. A user may position the line lock on the line at whatever point will be the upper limit of motion of the container assembly. As one example, the line lock may include a body, with the gripping member being a narrow slit in the body that grips a line. As another example, the line lock may include a body with a first channel extending through the body, a second channel spaced apart from the first channel and extending through the body and having a second hole width, and a slit extending at an angle partially through the body to the second channel and having a slit width that is less than the channel width. As another example, the gripping member may be a clamp, such as a spring biased clamp. As another example, the line lock may comprise a body of malleable material (e.g., a metal such as lead, steel, aluminum, brass, bismuth, tungsten or an alloy) with a slit in the body for receiving a portion of the line.

A sinker having a sinker weight is attached towards the free end of the line. The sinker weight exceeds the buoyant force. Thus, the buoyant force is sufficient to support the container assembly, but not sufficient to support the sinker weight.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A buoyant dispenser for fish bait or food comprising
a container assembly comprising
an outer surface defining a receptacle with an interior compartment for holding fish bait or food and an opening into the interior compartment, a plurality of perforations extending from the interior compartment through the outer surface, the outer surface defining the receptacle including an upper portion and a lower portion, an upper hole in the upper portion having an upper hole width, a lower hole in the lower portion having a lower hole width, the upper hole being aligned with the lower hole and, the upper hole extending from the interior compartment at the upper portion, the lower hole extending from the interior compartment at the lower portion, the upper hole and the lower hole in alignment defining a passage through the container assembly, the passage being configured to receive a line and allow sliding motion of the container assembly relative to the line, and a vent hole extending from the interior compartment at the upper portion, the vent hole being separate from the upper hole,
a cover removably attached to the receptacle over the opening,
a buoyant element that produces a buoyant force when the container assembly is submerged in water, said container assembly having a container assembly weight, the buoyant force exceeding the container assembly weight; and
a line lock including a line gripping member and having a line lock width greater than the upper hole width and greater than the lower hole width, the line gripping member releasably securing the line lock to a line; and
a sinker having a sinker weight, the sinker weight exceeding the buoyant force, the container assembly being disposed between the sinker and the line lock.

2. The buoyant dispenser for fish bait according to claim 1, the upper hole being formed in the cover removably attached to the receptacle over the opening.

3. The buoyant dispenser for fish bait according to claim 1, the lower hole being formed in the cover removably attached to the receptacle over the opening.

4. The buoyant dispenser for fish bait according to claim 1, the outer surface including a threaded neck through which the opening extends, and the cover threadedly engaging the neck.

5. The buoyant dispenser for fish bait according to claim 1, the cover snap fit to the opening.

6. The buoyant dispenser for fish bait according to claim 1, the buoyant element comprising a cork that fits through the opening in the container assembly and fits in the interior compartment of the container assembly.

7. The buoyant dispenser for fish bait according to claim 1, the buoyant element comprising a closed cell foam.

8. The buoyant dispenser for fish bait according to claim 1, the buoyant element comprising an inflated bladder.

9. The buoyant dispenser for fish bait according to claim 1, the buoyant element comprising a hermetically sealed hollow plastic float that fits through the opening in the container assembly and fits in the interior compartment of the container assembly.

10. The buoyant dispenser for fish bait according to claim 1, the buoyant element comprising a cork that fits through the opening in the container assembly and fits in the interior compartment of the container assembly, and the cork having a top and a bottom and a channel extending from the top to the bottom and defining a cork passage, the cork passage being alignable with the passage through the container assembly.

11. The buoyant dispenser for fish bait according to claim 1, the line lock including a body and the gripping member comprising a narrow slit in the body, the narrow slit gripping a line.

12. The buoyant dispenser for fish bait according to claim 1, the line lock including a body with a first channel extending through the body, a second channel spaced apart from the first channel and extending through the body and having a second hole width, and a slit extending at an angle partially through the body to the second channel and having a slit width, the slit width being less than the channel width.

13. The buoyant dispenser for fish bait according to claim 1, the gripping member comprising a clamp.

14. The buoyant dispenser for fish bait according to claim 1, the gripping member comprising a spring biased clamp.

15. The buoyant dispenser for fish bait according to claim 1, the line lock comprising a body of malleable material, the gripping member comprising a slit in the body.

16. A buoyant dispenser for fish bait on a line, the buoyant dispenser comprising
a container assembly comprising
an outer surface defining a receptacle with an interior compartment for holding fish bait and an opening into the interior compartment, a plurality of perforations extending from the interior compartment through the outer surface, the outer surface defining the receptacle including an upper portion and a lower portion, an upper hole in the upper portion having an upper hole width, a lower hole in the lower portion having a lower hole width, the upper hole being aligned with the lower hole and, the upper hole extending from the interior compartment at the upper portion, the upper hole being formed in the cover removably attached to the receptacle over the opening, the lower hole extending from the interior compartment at the lower portion, the upper hole and the lower hole in alignment defining a passage through the container assembly, the passage receiving the line and allow sliding motion of the container assembly relative to the line,
a cover removably attached to the receptacle over the opening,
a buoyant element that produces a buoyant force when the container assembly is submerged in water, said container assembly having a container assembly weight, the buoyant force exceeding the container assembly weight; and
a line lock including a line gripping member and having a line lock width greater than the upper hole width and greater than the lower hole width, the line gripping member releasably securing the line lock to the line; and
a sinker having a sinker weight, the sinker weight exceeding the buoyant force, the container assembly being disposed on the line between the sinker and the line lock.

17. The buoyant dispenser for fish bait according to claim 16, the outer surface including a threaded neck through which the opening extends, and the cover threadedly engaging the neck.

18. The buoyant dispenser for fish bait according to claim 17, the buoyant element comprising one of
a cork that fits through the opening in the container assembly and fits in the interior compartment of the container assembly;
a closed cell foam;
an inflated bladder;
a hermetically sealed hollow plastic float that fits through the opening in the container assembly and fits in the interior compartment of the container assembly; and
a cork that fits through the opening in the container assembly and fits in the interior compartment of the container assembly, and the cork having a top and a bottom and a channel extending from the top to the bottom and defining a cork passage, the cork passage being alignable with the passage through the container assembly.

19. The buoyant dispenser for fish bait according to claim 18, the line lock comprising one of
a body and the gripping member comprising a narrow slit in the body, the narrow slit gripping a line;
a body with a first channel extending through the body, a second channel spaced apart from the first channel and extending through the body and having a second hole width, and a slit extending at an angle partially through the body to the second channel and having a slit width, the slit width being less than the channel width;
a clamp;
a spring biased clamp; and
a body of malleable material, the gripping member comprising a slit in the body.

20. The buoyant dispenser for fish bait according to claim 19, further comprising a bobber attached to the line, the container assembly being disposed on the line between the sinker and the line lock, and the line lock being disposed on the line between the container assembly and the bobber.
